(19) United States
(12) Patent Application Publication
(10) Pub. No.: US 2002/0042784 A1
(43) Pub. Date: Apr. 11, 2002

(54) System and method for automatically searching and analyzing intellectual property-related materials

(76) Inventors: David S. Kerven, Atlanta, GA (US); Lance D. Reich, Smyrna, GA (US)

Correspondence Address: Dr. Davud S. Kerven, Esq., Needle & Rosenberg, P.C., Suite 1200, 127 Peachtree, St., N.E., Atlanta, GA, 30303, US

(21) Appl. No.: 09/973,501

(22) Filed: Oct. 8, 2001

Related U.S. Application Data
(60) Provisional application No. 60/238,566, filed on Oct. 6, 2000.

(51) Int. Cl. G06F 15/18

(52) U.S. Cl. 706/12

(57) ABSTRACT

The present invention relates to systems and methods for locating references related to a target intellectual property item in one or more accessible information storage systems. In accordance with the present invention, one or more search terms associated with the target item are received. Where possible, the received terms are expanded to include variations of interest. The expanded search terms are used to conduct searches in the accessible information storage systems. The search results are accumulated in a search result set. A report based upon the search result set is generated and transmitted to an output device. A typical system implementing the present invention includes a data store in communication with one or more processors.

### CROSS-REFERENCE TO RELATED PATENT APPLICATION

This application claims the benefit, pursuant to 35 U.S.C. §119(e), of applicants' provisional U.S. Patent Applications Serial No. 60/238,566, filed Oct. 6, 2000, entitled “SYSTEM AND METHOD FOR AUTOMATICALLY SEARCHING AND ANALYZING INTELLECTUAL PROPERTY-RELATED MATERIALS”, which application is hereby incorporated by this reference in its entirety for all purposes.

### BACKGROUND OF INVENTION

1. Field of Invention

The invention relates to a system and method for automatically searching and analyzing intellectual property-related materials. More specifically, this invention relates to a system and method for automatically searching a network of computers for materials related to a piece of intellectual property, or proposed trademark or patent claim, and for analyzing the results of such searching.

2. Description of Related Art

The Internet is a global network of connected computer networks. Over the last several years, the Internet has grown in significant measure. A large number of computers on the Internet provide information in various forms. Anyone with a computer connected to the Internet can potentially tap into this vast pool of information.

The most wide spread method of providing information over the Internet is via the World Wide Web (the Web). The Web consists of a subset of the computers connected to the Internet; the computers in this subset run Hypertext Transfer Protocol (HTTP) servers (Web servers). The information available via the Internet also encompasses information available via other types of information servers such as GOPHER and FTP.

Information on the Internet can be accessed through the use of a Uniform Resource Locator (URL). A URL uniquely specifies the location of a particular piece of information on the Internet. A URL will typically be composed of several components. The first component typically designates the protocol by with the address piece of information is accessed (e.g., HTTP, GOPHER, etc.). This first component is separated from the remainder of the URL by a colon (‘:’). The remainder of the URL will depend upon the protocol component. Typically, the remainder designates a computer on the Internet by name, or by IP number, as well as a more specific designation of the location of the resource on the designated computer. For instance, a typical URL for an HTTP resource might be:

http://www.server.com/dir1/dir2/resource.htm

where http is the protocol, www.server.com is the designated computer and /dir1/dir2/resouce.htm designates the location of the resource on the designated computer.

Web servers host information in the form of Web pages; collectively the server and the information hosted are referred to as a Web site. A significant number of Web pages are encoded using the Hypertext Markup Language (HTML) although other encodings using the eXtensible Markup Language (XML) or the Standard Generic Markup Language (SGML) are becoming increasingly more common. Web pages in these formatting languages may include links to other Web pages on the same Web site or another. Web servers, information servers of other types, await requests for the information that they host from Internet clients.

Client software has evolved that allows users of computers connected to the Internet to access this information. Advanced clients such as Navigator (Netscape) and Internet Explorer (Microsoft) allow users to access software provided via a variety of information servers in a unified client environment.

As the amount of information available via the Internet has grown, so too has grown the complexity of organizing and locating particular information of interest. Several key approaches have evolved to manage the wealth of available information. Likely the two most significant approaches are portals and search engines.

A portal is a Web site providing a topical hierarchical organization of other information resources available via the Internet. For example, a sports portal might provide a top-level selection of categories such as land sports, water sports and air sports. Selection of the water sports category might lead to a selection of categories such as swimming, boating and skiing. Selection of one of these categories might lead to further categories. In addition to the categories, links might exists to relevant information at other Web sites; for instance, the water sports level in the example above might include in addition to the categories links to information of general interest across all water sports such as information on good locations for engaging in a wide spectrum of water sports or information on emergency procedures for individuals who are drowning.

Search engines, on the other hand, begin with a set of keywords provided by the user and generate links to information potentially relevant to the provided set of keywords. Such a search is often more convenient than use of a portal as it generates links directly to relevant information rather than requiring navigation. A significant disadvantage to search engines is that the level of relevance of the information in the links can vary substantially from highly relevant to absolutely none.

In several areas, the use of such Internet information resulting from automated searching or portal usage has been taken a step further. In the areas such as finance and job search, some automated analysis is performed on the results of an Internet search. The analysis performed is tailored to the specific application domain.

In the area of intellectual property (IP), a variety of resources are available through the Internet; however, an effective automated system and method for searching and analyzing IP-related material has not previously been disclosed. In the IP area, several portals have been constructed and a variety of specialized Web sites have been developed to aid in searching.

Current IP portal Web sites provide links to a variety of reference of utility to practitioners in the IP areas. These references include IP law information, guides to registering or prosecuting IP, developing trends in the IP area and description of legal standards relevant to IP. Generally, these site do not provide substantive search capabilities with respect to particular IP.

A variety of technical portals and databases are available over the Internet. For instance, in the computer arts, the Association for Computing Machinery (ACM) digital library is available for searching over the Internet. These technical portals and databases provide access to a significant body of materials of potential interest to an IP search. However, these sites do not support automated evaluation of materials found in a search, particularly not with respect to IP specific criteria.

Several specific sites have been developed to aid in IP searching; however, these sites still lack support for automated evaluation and analysis of search results. The United States Patent and Trademark Office (USPTO) hosts a Web site that allows users to access a database of issued patents and a database of issued and pending trademark registrations. Searching such databases may yield relevant results. The results, however, are limited to the single database searched, and further, no tools are provided to analyze the search results.

The tools, Web-based Examiner Search Tool (WEST) and Examiners Automated Search Tool (EAST), replaced the Automated Patent Searching System (APS) in October 1999 as the online search tool available to those physically present at the USPTO. Both Examiners and Practitioners have criticized these new search tools available to those physically present at the USPTO as inadequate for performing rudimentary search functions. Further, these tools do not support automated analysis of the search results.

In addition to the USPTO, a variety of other specific sites would be of particular relevance to trademark searching. These sites might include the domain name databases managed by the various naming authorities for top-level domains. For instance, a search of the Network Solutions domain name database could be performed to look for existing or infringing uses of a mark as a domain name in the COM, NET or ORG top-level domain. Further, searching of Internet phone directories would have utility for searching for locating existing or infringing uses of a mark as a trade name. These databases are available over the Internet; however, tools do not exist to aggregate search information from these diverse source nor to analyze the results of such an aggregated search.

Similarly, in the patent field, in addition to the USPTO, intellectual property offices for various world nations such as Canada or jurisdictional units such as Europe provide Web sites. Many of these Web sites provide an interface to a searchable database of issued patents and/or pending applications. As with trademarks, these additional sites provide fertile ground for searching; however, tools for automated searching across multiple sites and tools for automated analysis of search results are lacking.

The related art systems previously described do not support the automated searching for IP-related materials from one or more computers distributed across a network of computers, nor do they support analyzing the IP-related materials generated by such a search.

### SUMMARY OF THE INVENTION

The present invention is a system and method for performing automated intellectual property (IP) searching and analysis. Typically, the method will involve a searching phase and an analysis phase. One preferred embodiment will also include a rating phase. Different embodiments may further include a criteria generation phase and/or a reporting phase. A typical system according to the present invention will include a data store for storing records created and/or modified during searching, rating and analysis and a network computer that includes a processor to execute the searching, rating and analysis functionality. In some embodiment, the searching, rating and analysis functionality may be distributed across one or more network computers. The network computer(s) may be permanently connected to the network, or selectively connected to the network as needed.

In a preferred embodiment, the searching phase will consist of a field of use search phase and an IP specific search phase. A generic search phase may optionally be performed. A criteria generation phase may be used to collect and expand the parameters of the search. In an alternate embodiment, the parameters of the search may be collected and/or expanded by a separate system and forwarded for use in the search phase. Typically, the search criteria for a trademark search will include a mark under investigation and for a patent search will include the elements of an actual or hypothetical patent claim.

In either type of search, the criteria may be expanded. In a trademark search, the search criteria may further include homonyms of the mark, common misspellings of the mark and alternate spellings of the mark. In a patent search, the search criteria may be expanded by expanding each element in the claim. The claim element may further include synonyms of the originally specified claim element. Expansion may also occur as a result of manual input by a user.

The rating phase will depend upon the type of IP search performed. In a trademark search, each document discovered via the search phase will be rated according to the frequency of occurrence of the mark in question within the document. Where variations of the mark are included in the search parameters, the occurrence count will include occurrence of both the mark and any included variations. Rating may also include analysis of context surrounding the mark usage utilizing information retrieval or artificial intelligence based techniques for document correlation.

In a patent search, each document discovered via the search phase will include one or more elements of the claim include in the search criteria. Associated with each document is an integer. The integer characterizes the elements of the claim found within the document. Rating may also include analysis of context surrounding the mark usage utilizing information retrieval or artificial intelligence based techniques for document correlation.

Analysis may occur with respect to the results of the search. In a trademark search, field of use search results are sorted by frequency of occurrence of the mark, or designated variations. Those documents with an occurrence count higher than a specified threshold are selected as relevant. If a generic search was performed, a similar process occurs; however, the threshold for selection of relevant document may be different. The results of the IP specific search are analyzed based upon the particular search; usually all results from these searches will be considered relevant. For instance, all domain names using the mark would be considered relevant to the search. In one embodiment, the relevant search results will be delivered to the initiator of the search such as via the Web, or other delivery platform.

In a patent search, field of use search results, IP specific search results and generic search results, if any, are sorted upon the basis of the assigned rating. Most likely combinations of reference yielding all claim elements may be presented. In either type of search, users may manually override the analysis and alter the rating of the various search results.

The search results will typically be stored in a data store, which may include a variety of storage elements. The storage elements may include any type of primary storage such as RAM (of any type), ROM (of any type), etc. and/or secondary storage such as magnetic media devices such as hard disk drives, floppy disk drives, cassettes, etc.; optical media devices such as CD-ROM burners or optical read-write drives; or even paper media such as paper tape or punch cards. A report is generated from the search results and outputted to any suitable output device such as a Web browser running on a user's computer, a facsimile, a printer, a storage element, etc. The report may be a simple output of the search result data or more complex as described more fully below. The report may further have editable elements in some embodiments whereby a user may review the search result, modify them based upon the review and submit changes for incorporation into the search result set prior to any analysis.

In some embodiments, further post processing may occur. For instance, with a search for patentability of a particular invention, the results may be post processed into a draft office action providing reason for rejecting the claim or into an information disclosure statement for submission in connection with a patent application. In the case of a patent invalidity study, the results may be post processed into a chart demonstrating invalidity of the claim based upon the search results.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 is a block diagram of a typical hardware architecture according to the present invention.

FIGS. 2A-D are flow charts of a typical process according to the present invention in the trademark area.

### DETAILED DESCRIPTION OF THE INVENTION

A preferred embodiment of the invention is now described in detail. Referring to the drawings, like numbers indicate like parts throughout the views. As used in the description herein, the meaning of “a,” “an,” and “the” includes plural reference unless the context clearly dictates otherwise. Also, as used in the description herein, the meaning of “in” includes “in” and “on” unless the context clearly dictates otherwise. The use of the phrase intellectual property shall include not only existing intellectual property in the form of issued patents and trademarks in use or applied for under intent to use but also proposed trademarks and patent applications.

Patent Related Art Analysis

In one aspect, the present invention supports analysis of art related to a patent, patent application or potential application. Such an analysis occurs with respect to an actual claim in the case of a patent or patent application or a hypothetical claim in the case of a patent application or potential application. A hypothetical claim with respect to a patent application might arise where a hypothetical amended claim is the subject of analysis. The term claim as used herein shall be construed broadly to include, without limitation, actual claims, hypothetical claims and less formal lists of invention features/limitations unless the context of use clearly dictates otherwise.

The art used in the analysis may either be generated through an automated or semi-automated search in one embodiment, as more fully described below. In another embodiment, search results are manually entered into the system.

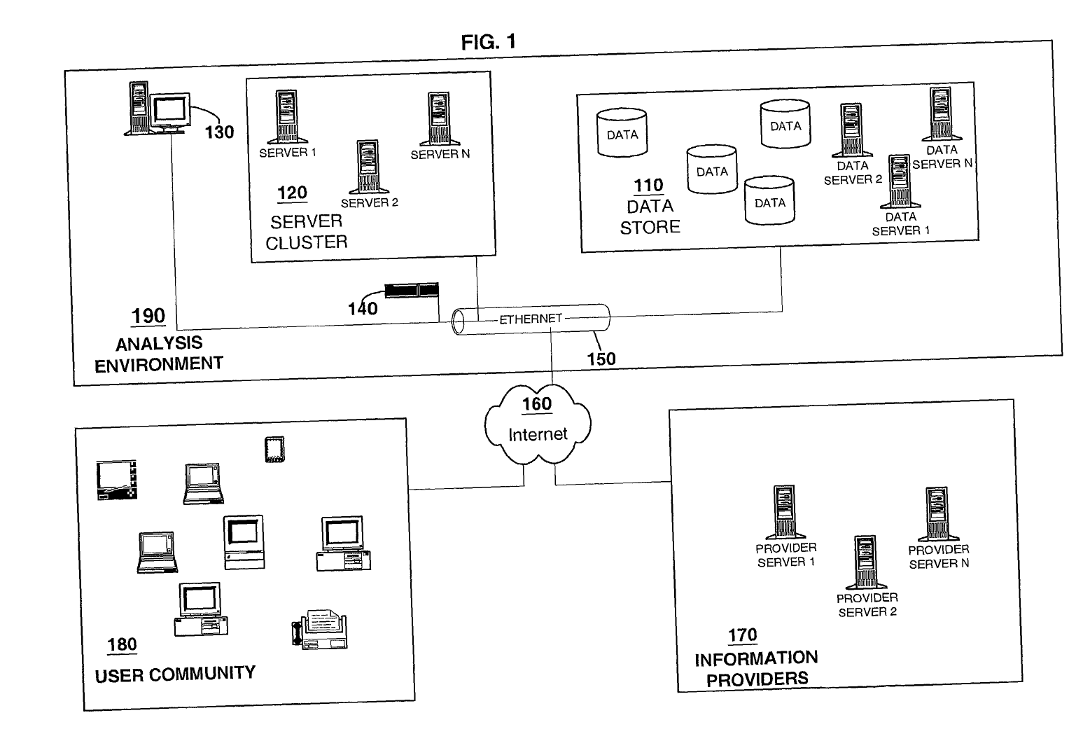

In one embodiment, the present invention includes includes a data store 110 and one or more servers in a server cluster 120. The data store 110 and one or more servers are in communication via suitable communications channel such as a bus, a computer network such as the Ethernet 150 shown in FIG. 1, a direct serial or parallel connection or other suitable link. In the typical architecture shown in FIG. 1, the environment 190 includes a router 140 to control communications within the Ethernet 150 and one or more load balancing devices 130 to allocate requests among the resources in the server cluster 120 and data store 110. The user community 180 accesses the environment through a communications link such as the Internet 160. The environment 190 accesses the information providers 170 via a communications link such as the Internet 160. Those skilled in the are will understand that other methods would work equally well to support access by the user community and access to the information providers; further, the access method may vary from member to member within the user community or from provider to provider among the information providers. In one simple embodiment, the environment may consist of a single computer system with a processing unit and local bus connected storage that is accessible by the user community and that has access to the information providers. In embodiments where the search results are provided rather than generated via an automated or semi-automated search of the information providers, a connection to the information providers is not necessary. Further, in embodiments where users of the user community have direct access to the environment (e.g. direct access to the single computer system embodiment), a communications channel to the user community is not necessary.

A typical embodiment of the analysis tool will include a data store populated by references to the related art; in some embodiments, the data store may also include the related art items themselves. The data store may have a variety of architectures such as a database, a hash table, a flat file or some combination thereof; as will be understood by those skilled in the art, other data store architectures may be used within the scope of the present invention.

A database embodiment could utilize any conventional database organization such as object oriented, relational, object-relational, hierarchical, spatial or other hybrid organization. In a relational organization, such as used in Access by Microsoft (Redmond, Wash.), the related art references would be represented in tables of data. A typical table organization would include: a location field identifying where the reference may be found, a date field indicating one or more dates associated with the reference and one or more fields characterizing the reference in relation to the claim subject to analysis. In an object oriented organization, such as used by Object Store, the related art would be represented as objects. A typical class definition for such objects would include attributes analogous to the fields described above with respect to a typical relational table. Organization via hierarchical, spatial or any hybrid model would encompass utilization of similar fields/attributes. Depending upon the implementation other fields/attributes might be used within the scope of the invention.

In a hash table architecture, each related art reference would be represented as a record. Each record might typically include the fields as described above with respect to entries in a typical relation table representation. The records could be placed in hash table buckets by performing a hashing function on one field of the record. In the typical record described, the location field may be used for this purpose, as it is likely to be the most distinct. Assuming the content of this field is a character string such as a URL, a typical hashing function might sum the ASCII values of the characters in the string and take the remainder of dividing this sum by the number of buckets in the hash table. As will be known by those skilled in the art, other hashing functions and algorithms are well known and could be used with equal facility in the present invention. The value generated by the hashing function for a record is used as an index into the hash table for location and placement of the record in a bucket. The bucket may consist of a linked list of records that have hash values corresponding to the bucket. Alternatively, the bucket may consist of a further hash table wherein location and placement of records in buckets depend upon the use of a different hashing function on the location field or upon the use of the same or different hashing function on another field of the record such as the characterization field, or one of the characterization fields if more than one is present. The buckets in this second level hash table would consist of a linked list of records or further levels of hash tables.

Any number of flat file implementations could be used as the architecture. In one such embodiment, the flat file could consist of character delimited tables representing the data where each row of data would include the same types of data described above with respect to the relational database architecture.

The location field as described above may, in one embodiment, store a URL corresponding to the unique electronic location of the related art reference represented by the entry. For non-electronic references, the location field might store a unique string indicating the location of the non-electronic reference. In one embodiment, this string could be analogously formatted to a URL; for instance, each physical reference could be assigned a string of the form:

physical:ref#

where # is replaced by a number. The number could be assigned when the reference is added to the data store by starting at some fixed number (e.g. 1) and by incrementing the previously assigned number by one, or some other amount. The data store, in such an embodiment, would support appropriate structures to provide a correlation between such a location string and some description of the actual location of the reference. For example, in a relational database context, a table could correlate location strings to textual descriptions of the items' actual physical location. In a hash table-based data store, records correlating location strings to actual location could be a hash table records hashing on the location string or simply a flat file of records subject to sequential search.

The date field will typically support month, day and year subfields. In some embodiments, subfields of the date field or multiple date fields might be used to allow for either multiple dates or date ranges.

Each related art reference will be characterized with respect to the claim subject to analysis. One or more fields will be associated with each reference to store the characterization. One element flag field will, in a typical embodiment, be a small number of integers, usually one 32-bit integer. Each element of the claim subject to analysis will have a corresponding bit in this field. If a claim element is determined to be disclosed in a reference, the bit corresponding to that claim element is set to one in the characterization field associated with the reference. Alternatively, a subfield could exist for each claim element where each subfield would be a flag indicating whether the claim element is disclosed in the associated reference; in some embodiments taking this approach, the subfield might further contain a list of locations in the reference pertaining to claim element corresponding to the subfield.

An additional integer field could be used to store the number of claim elements disclosed within the particular reference; the value stored in this field could be calculated as the summation of the set bits in the element flag field or of the set sub fields. This value may be used as a factor in evaluating the level of relevance of the particular reference to the claim subject to analysis. The closer the value is to the number of elements in the subject claim, the greater the potential relevance of the reference.

In some embodiments, the data store may also be used to store the claim subject to analysis, and possibly additional information concerning the claim. A separate claim data store could be used with equal facility within the scope of the present invention. In other embodiments, the claim may not need to explicitly stored; rather, the claim limitations are implicitly saved as part of the characterization field of related art references in the data store.

The representation of the claim in the data store will typically be stored as a list or table of features (also referred to as limitations or elements) of the subject invention. The features may be represented in any suitable format; typically, they will be stored as textual descriptions. In a relational database architecture for the claim data store, the claim may be stored as a table including fields for an element number, the textual description of the element and possibly additional fields.

Some embodiments may store the specification associated with the claim subject to analysis in the data store. As with storage of the claim, a separate specification data store may be used. In other embodiments, the specification is not stored and/or used.

In some embodiments, one or more pointers to locations within the specification supporting a particular claim element may be associated with the element and suitably represented in the data store. In a particular embodiment, these stored pointers correspond to hypermedia links linking the element to the portions of the specification supporting that element.

In some embodiments, one or more expansion terms may be associated with a particular claim element and suitably represented in the data store. Generation of such expansion terms is described more fully below.

As will be known to those skilled in the art, the claim and/or specification, in embodiments storing either or both, may store them, or portions of them, in a variety of formats within the scope of the present invention. The text of the claims and/or specification, or portions thereof, may be stored and/or accessed any suitable format including, but not limited to, HTML, XML, ASCII, SGML, Microsoft Word, Corel Word Perfect or other suitable document formatting or modeling standard.

The data store may be accessed via a communication channel such as the Ethernet of FIG. 1 by the one or more servers in the server cluster. In one embodiment where the data store includes one or more database servers, one or more servers in the server cluster may serve as focal points for data access. In one embodiment, data access could occur through standard Windows NT servers running an Allaire Cold Fusion server or similar database/Web interface. Alternatively, application servers such as iPlanet Application Servers or IBM WebSphere servers utilizing a JDBC interface could provide the data access. In addition to data access, these servers may also support the rating and analysis functionality, as more fully described below, through appropriate business logic software which may be coded in any suitable programming language. In a typical embodiment, the business logic would be encoded as Enterprise Java Beans (EJB) or CORBA objects; such encoding may impact the selection of the programming language for developing the business logic.

Servers in the server cluster would also be responsible for interacting with users in the user community, typically through a Web-based interface; consequently some of the servers in the server cluster may run appropriate Web server software such as Apache, iplanet Enterprise, Microsoft Internet Information Server, or other suitable Web server software. The Web servers would, in turn, communicate with the application and/or data access servers to provide generate dynamic pages to the user community requesting necessary information and presenting desired results.

The application servers would also include the functionality necessary to accomplish searching in such embodiments where automated or semi-automated searching occurs. In one embodiment, appropriate Java servelet technology is used to perform the searching functionality.

Those of skill in the art will understand that the functionality as described above may be hosted through one or more computer systems. In embodiments utilizing multiple computer systems, the functionality may be distributed among the physical hardware assets as appropriate.

In a typical process according to the present invention, a search phase may occur. However, in some embodiments, only an analysis phase may occur with respect to a preexisting set of references; in some such embodiments, a reporting phase may also be performed.

In all cases, a claim must be specified either explicitly or implicitly. Implicit claim specification may occur based upon the extraction of the claim elements from a pre-existing set of categorized references in a data store. In most embodiments, explicit claim specification will occur.

Explicit claim specification may occur in a variety of ways including, without limitation:

1) manual entry of the claim elements through an appropriate interface,

2) automated extraction of claim elements from a preformatted patent or application document, and

3) automated extraction to pre-populate an appropriate interface combined with manual refinement via the interface.

Examples of manual entry would be via a user interface form (such as an HTML FORM element) allowing a user to designate each element of the claim. Automated extraction may occur preferably via an application or patent in a suitable document formatting language such as HTML, XML, SGML, Word, WordPerfrect, etc. In one embodiment, the claim could be specified by patent number and claim number where the element is extracted from the formatted patent. The formatted patents could be obtained via an appropriate communication channel such as a computer network. In one embodiment, the formatted patents could be available via the Internet from such sites as provided by the U.S. Patent Office or IBM's Intellectual Property Network Server. Where applications are subject to publication, applications may be available in a similar manner by application serial number and claim number. Where preformatted applications and/or patents are available, the specification of the patent or application may be obtained in those embodiment supporting use of the specification. Further, the field of the invention in the form of technical classification of the patent/application may also be parsed from preformatted documents where such information is available; where such information is not available, some embodiment may allow entry of the technical classification of the invention via an appropriate interface.

Once the claim has been specified, an optional expansion process may occur wherein each individual element of the claim is expanded. The expansion may occur through the inclusion of synonyms and functional equivalents derived from a generic thesaurus, or an art specific thesaurus in embodiment where the technical classification of the invention is available. In some embodiments where the specification is available, expansion may occur through contextual analysis of the specification regarding support for the particular elements; the context may be found utilizing standard information search and retrieval techniques on an element-by-element basis utilizing the particular element as a basis. In some embodiments, the expanded elements of the claim may be subject to manual refinement by a user.

The elements, expanded elements in certain embodiments, are then used to search on an element-by-element basis. Standard Web search engine technology may be applied to generate general search results for from the Web. For IP specific search or technology specific searches, search templates may be created to interface with specific sites of interest. In some embodiments, the specific sets of technology specific sites may be selected based upon the technical classification of the invention. For instance, the IP specific search would include search engine technology enhanced with templates for interfacing with IP specific sites such as the U.S. Patent Office's online full text database, IBM's Intellectual Property Network and the European Patent Office's online searchable database. Technology specific sites would be targeted based upon the technical classification. Generic digital library sites such as provided by Dialog and Lexis/Nexis may be targeted by utilizing interfaces and templates to existing search technology that limit the searches of such libraries to specific areas associated with the technological classification for the invention.

Each time a hit results from any of the searches, a check is made to determine if that hit occurred with respect to a prior element or via another source. If the hit is new, an entry for the reference is created in the data store along with an indication in the characterization field is made based upon the current element being searched. Appropriate date information is extracted from the reference and stored where such information is available. The area of the reference where the element was found may also be stored in some embodiments. In some embodiments, a copy of the reference is obtained and stored in the data store. If the hit was found previously, appropriate updates are made to the characterization field for the reference's entry in the data store, and in certain embodiments, location information regarding the current element is also stored. In embodiments utilizing a bit string (one or more integers) to represent the characterization field, the characterization field update or initialization may occur by starting with a bit string populated by zero's, setting a single one in the location corresponding to the element subject to the current search, applying a bitwise OR operation to the existing characterization field (new entries are assumed to have a characterization bit string totally populated by zero's) and storing the result back into the characterization field. A total field associated with the reference may track the accumulated number of elements found in the reference, or this value may be calculated dynamically by counting the number set flags, bits or entries in the characterization field. A further rating of the reference may be performed when its entry is created or only after a threshold number or percentage of elements is found in the reference. One such rating could be a correlation of the textual similarity between the located reference and the specification associated with the claim and/or between the located reference and the claim in its entirety generated using standard information search and retrieval techniques. In some embodiments, an interface may be provided by which a user may modify or fine tune the automatically generated ratings associated with the references. Such modifications may occur either prior to or subsequent to an analysis phase.

Once a search phase is complete or search results are provided, an analysis phase will occur. In analysis, the located references may be sorted and/or filtered. A percentage of references deemed least relevant may be removed from the analysis and data store in some embodiments where relevance may be determined by assigned ratings, number of other references including the same element and other suitable metrics. The results may then be sorted, or resorted in some embodiments, according to a set standard or according to preferences of the users. The sorting may be according to element count, correlation ratings, characterization fields or other suitable sorting criteria. Some embodiments may utilize a combination of these criteria or sort in a tiered fashion wherein overall sorting occurs with respect to one criteria and sorting within tiers or subtiers is based upon one or more other criteria.

References that represent a potential novelty issue can be identified by locating all reference that have an element count equal to the number of elements in the claim. Alternatively, or in addition, in embodiments using a bit string characterization field, all references having a bit string that when converted to an integer value is equal to 2ⁿ−1 where n is the number of elements in the claim would be those raising potential novelty problems.

Combinations of references that combine to include all elements of the claim may represent potential obviousness issues with respect to the claim subject to the analysis. These combination can be identified by performing pair-wise, triplet-wise, . . . , n-tuple-wise comparisons. In embodiments utilizing a bit string characterization field, identifying combinations of references can be performed by at each comparison bitwise OR'ing the characterization fields of the references in the comparison, converting the resultant bit string into an integer and comparing that integer to 2ⁿ−1 where n is the number of elements in the claim. Where the derived integer is equal to 2ⁿ−1, the current combination represents a potential obviousness issue.

Where the analysis indicates that a single search result includes all elements of the claim subject to analysis, a novelty problem or an infringement may be present. Where the analysis indicates a combination of search results to yield all elements of the claim subject to analysis, an obviousness issue, or potentially indirect infringement, may be present.

The results of the analysis phase may be put to a number of uses. Each such use may involve post processing of the result into a use suitable report. Five such uses and appropriate reports are detailed as follows:

1. Prefiling Screening. The tool may be used to screen a potential invention for patentability. The results of the analysis phase will include single search results including all elements of the claim subject to analysis and the most likely combinations of search results including all elements of the claim. These analytical results represent potential novelty or obviousness bars to patentability. The results could be formatted into a draft patentability opinion for review, revision and finalization by an attorney.

2. Application Examination. Governmental authorities responsible for review and issuance of patent may utilize the present invention to streamline the examination process. The results of the analysis may indicate rejections of the subject claim for lack of novelty and/or obviousness. These results may be processed into a report that is a draft office action for review, revision and finalization by an Examiner.

3. Infringement Locator. Institutions and individuals with large patent portfolios face the daunting task of policing their portfolio. The search results provide a quick initial list of potential infringers. All results that include all elements of the subject claim could be potential infringers of the subject claim. The results could be post processed to provide a list of the results along with the positions of each found element of the claim as hyperlinks or other suitable pointers for use by an attorney in evaluating whether the potential infringer should be contacted concerning the potential infringement.

4. Invalidity Study. In instances where an individual or institution is faced with a threat of suit by a patent holder, one defense to patent infringement is the invalidity of the claims in the subject patent. The results of the analysis phase will include single search results including all elements of the claim subject to analysis and the most likely combinations of search results including all elements of the claim. As a consequence, these results could be formatted into a claim table documenting prior art and the elements of the claim to which they apply. Further, the analysis could provide a listing of individual references or the most likely combinations that may lead to invalidation of the subject claim.

5. Purchaser Diligence. This usage would be appropriate to someone looking to acquire a patent or pending application. The results would yield a combination of the infringement locator and either invalidity for a patent or prefiling screening for a pending application. The generated report would provide some idea as to the value of the asset being evaluated for purchase by indicating a number of potential infringers and by indicating either whether the patent will withstand a validity challenge or whether the patent may face problems to issuance. In the latter situation, the purchaser may request that the additional art be cited to the Patent Office in a supplemental information disclosure statement.

Trademark Analysis

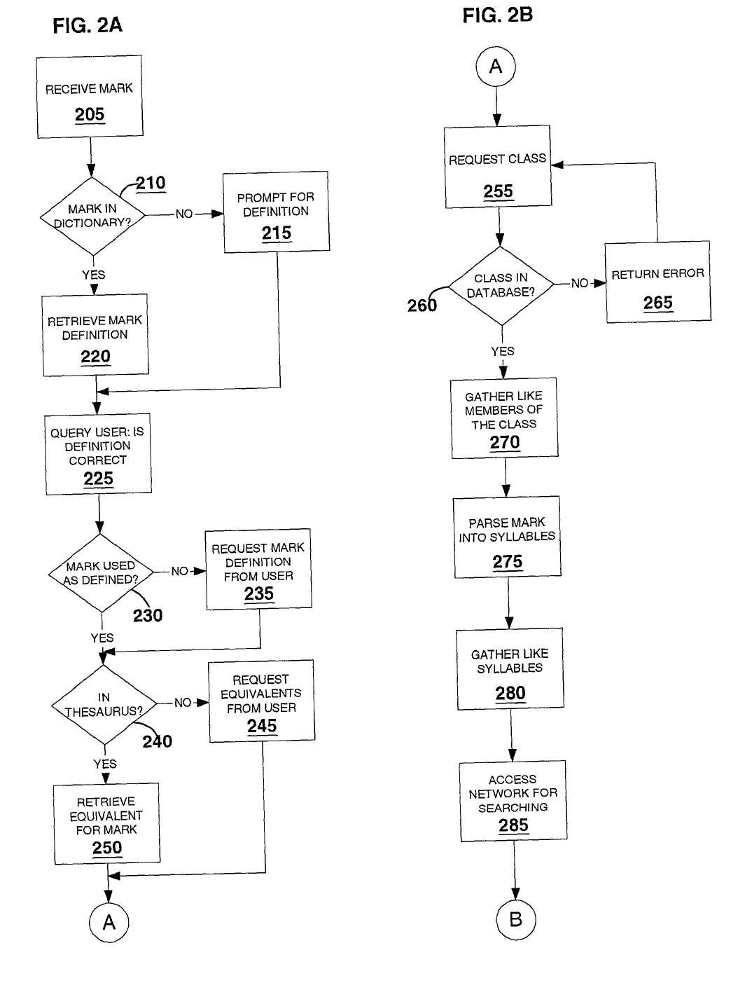

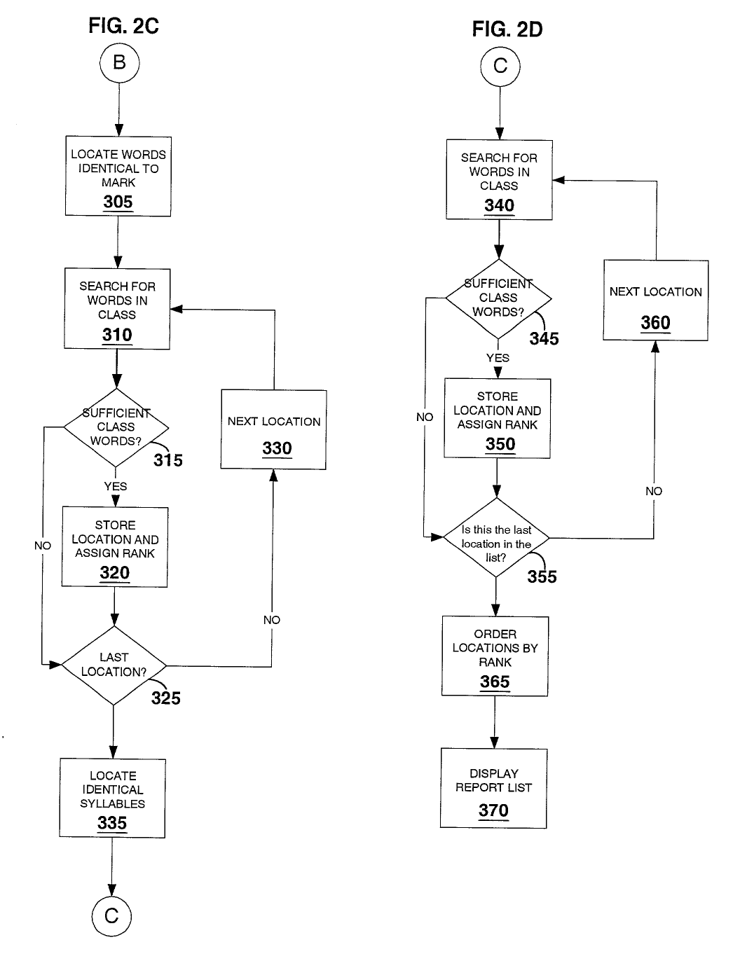

The methods and systems described above lend themselves to utilization in search and analysis with respect to trademark and proposed trademarks. A user may specify a trademark or proposed trademark for searching and analysis. FIGS. 2A-2D provide a flow chart of a typical process according to the present invention, the steps of which are summarized in below.

[205] Receive input of trademark

[210] Is the trademark present in the dictionary? If yes, proceed to [220]. If no, proceed to [215].

[215] Prompt user for definition of the trademark. Proceed to [225]

[220] Retrieve the definition of the mark.

[225] Query user about the correctness of the definition for use of the trademark.

[230] If definition affirmed, proceed to [245]. If not, continue to [240].

[235] Request definition of trademark from user.

[240] Are there equivalents in the thesaurus for the trademark? If yes, proceed to [250]. If not, continue with [245].

[245] Request words having an equivalent meaning to the mark. Continue with [255].

[250] Retrieve equivalents for the mark.

[255] Request the user to enter the class for the mark.

[260] Is the class valid. If yes proceed to [270]. If not, continue to [265].

[265] Return an error message and return to [255].

[270] Gather like members of class.

[275] Parse mark into syllables.

[280] Gather like syllables.

[285] Access network for searching.

[305] Locate identical words to the mark on the network.

[310] Search the location for words in the class.

[315] Is there a predetermined amount of class words present at the location? If not, proceed to [325]. If yes, continue with [320].

[320] Store location and assign a rank.

[325] Is this the last location in the list? If not, proceed to [330]. If yes, continue with [335].

[330] Goto next location and continue with [310].

[335] Locate identical syllables to mark syllables.

[340] Search the location for words in the class.

[345] Is there a predetermined amount of class words present at the location? If not, proceed to [355]. If yes, continue with [350].

[350] Store location and assign a rank.

[355] Is this the last location in the list? If not, proceed to [360]. If yes, continue with [365].

[360] Goto next location and continue with [340].

[365] Order the locations by rank.

[370] Generate and display reporting list to users.

Some embodiment may include a term expansion phase including one or more of the following approaches. A homonym dictionary may be searched to expand the specified mark. Term expansion may include partial substitution of components of the mark and/or other terms from earlier expansion with common misspellings. In addition, a foreign language dictionary may be used to generate foreign language equivalents of the mark and/or other terms from earlier expansion. The expanded

A description for the goods or services for the trademark or proposed trademark may also be utilized by some embodiments. In some embodiments, descriptions for registered marks may be automatically derived from existing online databases such as provided by the USPTO. In some embodiments utilizing this approach, the derived description may be presented to the user for review, revision and approval. In instance where the mark is registered in multiple classes, the user may be presented with an opportunity to select the desired description of goods and/or services. If the specified mark is a proposed mark, the user may be provided with an opportunity to enter a desired description via an appropriate user interface.

A search is then conducted utilizing existing conventional or proprietary search technology over a computer network for instances where the specified mark, or any term generated during an expansion phase, is used. In some embodiments, a filter may then remove from consideration any search results that meet a prespecified set of criteria established by the user. For example, where the searched computer network is the Internet, the filter may exclude results from particular URL, or set of URLs, containing a particular phrase; thus, a company could exclude references to uses of the specified mark within its own Web site.

The search results could then be presented to the user via an appropriate interface. Some embodiments may include an ordering of results based upon similarity to the specified mark. For example, content using the specified mark would be presented first, content using terms generated via an expansion phase and content using terms similar to the specified mark next, and finally content using terms similar to terms generated via an expansion phase.

In embodiments where a description is specified, further analysis may be performed allowing a finer ordering of the results. A contextual analysis may be performed using standard information retrieval techniques to determine a correlation between the description associated with the specified mark and the context in the content of the search result surrounding the term that led to the particular content to be selected as a result of the search. In one embodiment, all search results may be ordered in this manner; in other embodiments, the results within categories such as those identified above with respect to embodiments ordering results independent of any description information. The correlation may also be determined via other appropriate techniques such as artificial intelligence techniques including fuzzy logic, neural network, genetic algorithms and the like.

Throughout this application, various publications may have been referenced. The disclosures of these publications in their entireties are hereby incorporated by reference into this application in order to more fully describe the state of the art to which this invention pertains.

The embodiments described above are given as illustrative examples only. It will be readily appreciated by those skilled in the art that many deviations may be made from the specific embodiments disclosed in this specification without departing from the invention. Accordingly, the scope of the invention is to be determined by the claims below rather than being limited to the specifically described embodiments above.

What is claimed is:

1. A system for locating references related to a target mark, actual or potential, in one or more accessible information storage systems, the locating system comprising:
(a) a data store comprising one or more storage elements;
(b) one or more processors in communication with each other an the data store, the one or more processors for:
(i) receiving the target mark comprising one or more mark terms;
(ii) creating a search phrase by:
(1) initializing the search phrase to include the mark terms;
(2) identifying variations for any of the mark terms, wherein the identified variations are of a type selected from the group consisting of homonyms, translations and common misspellings; and
(3) if any variations were identified, adding the identified variations to the initialized search phrase;
(iii) generating a search result set by:
(1) conducting one or more searches in one or more accessible information storage systems based upon the created search phrase; and
(2) accumulating results from each of the conducted searches in the search result set;
(iv) storing the search result set in the data store;
(v) prioritizing the elements of the search result set;
(vi) generating a report based upon the search result set; and
(vii) transmitting the report to an output device.

2. The locating system of claim 1, wherein the one or more storage elements comprises at least one storage element that stores data on removable media.

3. A system for locating references related to a target claim, from a patent or proposed for a patent application, in one or more accessible information storage systems, the locating system comprising:
(a) a data store comprising one or more storage elements;
(b) one or more processors in communication with each other an the data store, the one or more processors for:
(i) receiving one or more phrases, wherein each received phrase represents a limitation of the target claim and comprises one or more terms;
(ii) for each received phrase, creating an expanded search phrase by:
(1) initializing the expanded search phrase to include the terms of respective received phrase;
(2) identifying synonyms for any term within the respective received phrase; and
(3) if any synonyms were identified, adding the identified synonyms to the initialized expanded search phrase;
(iii) generating a search result set by:
(1) for each expanded search phases, conducting one or more searches in one or more accessible information storage systems based upon the respective expanded search phrase;
(2) accumulating results from each of the conducted searches in the search result set;
(iv) storing the search result set in the data store;
(v) prioritizing the elements of the search result set;
(vi) generating a report based upon the search result set; and
(vii) transmitting the report to an output device.

4. The locating system of claim 3, wherein the one or more storage elements comprises at least one storage element that stores data on removable media.

5. A method for locating references related to a target intellectual property item, actual or proposed, in one or more accessible information storage systems, the method comprising:
(a) receiving one or more search phrases associated with the target item, wherein each received search phrase comprises one or more search terms;
(b) for each received phrase, creating an expanded search phrase by:
(i) initializing the expanded search phrase to include the search terms of respective received search phrase;
(ii) identifying variations for any search term within the respective received phrase; and
(iii) if any variations were identified, adding the identified variations to the initialized expanded search phrase;
(c) generating a search result set by:
(i) for each expanded search phases, conducting one or more searches in one or more accessible information storage systems based upon the respective expanded search phrase;
(ii) accumulating results from each of the conducted searches in the search result set;
(d) generating a report based upon the search result set; and
(e) transmitting the report to an output device.

6. The method of claim 5, wherein the receiving step comprises the steps of:
(i) receiving a document selected from the group consisting of a patent, a patent application, a trademark registration and a trademark registration application; and
(ii) extracting the one or more search phrases from the received document.

7. The method of claim 6, wherein the receiving step further comprises the steps of (iii) receiving a reference to the document and (iv) transmitting a request for the document to an information storage system based upon the received reference.

8. The method of claim 1, and further comprising the step of storing the search result set in a data store.

9. The method of claim 1, and further comprising the step of storing the generated report in a data store.

10. The method of claim 1, wherein the generated report comprises one or more fields that upon receipt by the output device allow a user to edit contents of the one or more fields and further comprising the steps of (f) receiving one or more modifications to the report corresponding to input by the user into the one or more fields and (g) modifying the report or the search results set based upon the received one or more modifications.

11. The method of claim 10, and further comprising the step of repeating steps (d) through (g).

12. The method of claim 1, and further comprising the step of prioritizing the search result set.

13. The method of claim 12, wherein the target item is a mark, further comprising the step of accessing one or more descriptions of goods or services associated with the mark, and wherein the prioritizing step comprises the steps of:
(i) calculating a correspondence value between each element of the search result set and each of the one or more descriptions; and
(ii) sorting the elements of the search result set based upon the calculated correspondence values.

14. The method of claim 12, wherein the target item is a claim, further comprising the step of accessing a technical description of an invention corresponding to the claim, and wherein the prioritizing step comprises the steps of:
(i) calculating a correspondence value between each element of the search result set and the technical description; and
(ii) sorting the elements of the search result set based upon the calculated correspondence values.

15. The method of claim 12, wherein the prioritizing step comprises the steps of:
(i) calculating a frequency count associated with each element of the search result set; and
(ii) sorting the elements of the search result set based upon the calculated frequency count.

16. The method of claim 15, wherein the target item is a mark and wherein the frequency count calculating step comprises counting occurrences of any expanded search phrase within each element of the search result set.

17. The method of claim 15, wherein the target item is a claim and wherein the frequency count calculating step comprises counting occurrences of different expanded search phrases within each element of the search result set.

18. The method of claim 1, wherein the target item is a claim and wherein the receiving step comprises receiving a single search phrase comprising the mark.

19. The method of claim 18, wherein the step of identifying variations comprises identifying variations of one or more types selected from the group consisting of homonyms, translations and common misspellings.

20. The method of claim 18, and further comprising the step of attempting to create additional expanded search phrases by selectively parsing and regrouping the one or more search terms of the received single search phrase.

21. The method of claim 18, wherein the generated report is selected from the group consisting of a draft registrability analysis, a draft infringement analysis, a draft office action and a table of results.

22. The method of claim 1, wherein the target item is a claim and wherein the receiving step comprises receiving a search phrase corresponding to each limitation of the claim.

23. The method of claim 23, the step of identifying variations comprises identifying synonyms.

24. The method of claim 23, wherein the generated report is selected from the group consisting of a table of results, a draft patentability analysis, a draft infringement analysis, a draft invalidity analysis, a draft office action, a draft search report and a draft written opinion.

25. The method of claim 23, and further comprising the step of identifying any elements of the search result set that include at least one occurrence of each expanded search phrase.

26. The method of claim 23, and further comprising the step of identifying pluralities of elements of the search result set that, in combination, include at least one occurrence of each expanded search phrase.

27. A system for locating references within one or more data sets, wherein each data set comprises a potential intellectual property reference, the one or more data sets accessible on a network, the system comprising:
(a) one or more processors in selective communication with the network;
(b) an intellectual property search engine resident on the one or more processors, the intellectual property search engine:
(i) selectively receiving one or more search terms;
(ii) expanding the one or more search terms to create a search data set;
(iii) performing one or more searches of at least one potential intellectual property reference data set via the network;
(iv) comparing the search data set to the potential intellectual property reference data set;
(v) returning potential intellectual property reference data sets based upon the comparison between the search data set and the potential intellectual property reference data set.
